(19) United States
(12) Patent Application Publication
(10) Pub. No.: US 2013/0181082 A1
(43) Pub. Date: Jul. 18, 2013

(54) Interchangeable Fishing Reel Assembly

(71) Applicant: Scott H. Smith, Medford Lakes, NJ (US)

(72) Inventor: Scott H. Smith, Medford Lakes, NJ (US)

(21) Appl. No.: 13/352,600

(22) Filed: Jan. 18, 2012

(51) Int. Cl. A01K 87/06

(52) U.S. Cl. 242/316

(57) ABSTRACT

An interchangeable fishing reel assembly has a reel housing with opposing top and bottom surfaces and a laterally extending cranking handle. Screw attachments connect the fishing rod supporting foot member to the top surface of the reel housing to permit the handle to be simply and effectively utilized by a right-handed fisherman, The foot member is detachable from the top surface and configured to be secured to the bottom surface of the reel housing, in order to allow the reel assembly to be effectively used by a left-handed fisherman, The laterally^{,} extending handle at all times remains in the same location, extending from the reel housing, thus reducing the number of openings in the housing and preserving the waterproof integrity of the housing.

### BACKGROUND OF THE INVENTION

Conventional fishing reels generally are either produced for right-handed fishermen or they are manufactured utilizing some type of reversible assembly in which the reel's cranking handle can be interchangeably installed on either side of the reel housing to accommodate both right or left-handed fishermen. Use of the conventional, right-handed reels by left-handed anglers often results in awkward positioning of the reels and their attached fishing rods, thus creating difficulty during the fishing process. Reversible handle reels, while they have sonic degree of versatility, present a separate problem. The use of a single cranking handle which is detachable and reattachable to either side of a reel housing must be connected to openings located on both sides of the housing. While attempts are made to close off the openings, especially the opening which is not connected to the cranking handle, water too often enters through the openings, thus compromising the integrity of the housing. As the reel gearing central to the operation of the reel is enclosed within the reel housing, water, especially sea-water, presents a real threat to the operation of the reel gear system.

There is currently no fishing reel assembly which can be alternately and easily used by both right and left handed fishermen, while still maintaining the waterproof integrity of the reel housing.

### SUMMARY OF THE INVENTION

It is thus the object of the present invention to provide an interchangeable fishing reel assembly which overcomes the limitations and disadvantages of prior such assemblies.

It is the object of the present invention to provide an interchangeable fishing reel assembly which allows for the efficient and simple conversion of a fishing reel from right-handed cranking to a left-handed cranking and vice versa.

It is a further object of the present invention to provide an interchangeable fishing reel assembly which permits the cranking handle to remain in the same position in relation to the reel housing, even when the reel assembly is being converted between right-handed and left-handed cranking rotation.

It is still another object of the present invention to provide an interchangeable fishing reel assembly which assists in maintaining the waterproof integrity of the reel housing during conversion between right-handed and left-handed cranking interchange and at all times thereafter.

It is another object of the present invention to provide an interchangeable fishing reel assembly which reduces the number of openings within the reel housing, thus enhancing the waterproof integrity of the housing.

These and other objects are accomplished by the present invention, an interchangeable fishing reel assembly having a reel housing with opposing top and bottom surfaces and a laterally extending cranking handle. Screw attachments connect the fishing rod supporting foot member to the top surface of the reel housing to permit the handle to be simply and effectively utilized by a right-handed fisherman. The foot member is detachable from the top surface and configured to be secured to the bottom surface of the reel housing, in order to allow the reel assembly to be effectively used h left-handed fisherman. The laterally extending handle at all times remains in the same location, extending from the reel housing, thus reducing the number of openings in the housing and preserving the waterproof integrity of the housing.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an elevation view of the interchangeable fishing reel assembly of the present invention, configured for use by a left-handed fisherman.

FIG. 2 is an elevation view of the interchangeable fishing reel assembly of the present invention, showing the manner of detachment of its foot member from the reel housing.

FIG. 3 is an elevation view of the interchangeable fishing reel assembly of the present invention, with the foot member secured to the bottom surface of the reel housing.

FIG. 4 is an elevation view of the interchangeable fishing reel assembly of the present invention, repositioned from that which is shown in FIG. 3 and configured for use by a right-handed fisherman.

### DETAILED DESCRIPTION OF THE INVENTION

Fishing reel assembly 1 comprises reel housing 2, laterally extending cranking handle 4, and flyer unit 6 and spool 8, both rotatable in relation to the reel housing. Cranking handle 4 is permanently attached to and positioned on a single location on one side of reel housing 2. Reel housing 2 has top surface 10 and opposing bottom surface 12 and encloses gearing (not shown) which serves to rotate flyer unit 6 and spool 8, upon rotation of cranking handle 4. The manner of rotation of the reel components by this gearing is known in the art and forms no part of the present invention.

Foot member 14 comprises upper section 16, configured to support and secure a fishing rod, lower base section 18, and intermediate section 20 interconnecting the upper section and lower base section. Lower base section 18 is configured to be secured to top surface 10 of reel housing 2 by means of threaded screws or equivalent attachment means 22 and 24, extending into openings 23 and 25 in the base section and. then through corresponding threaded openings 26 and 28 in the housing.

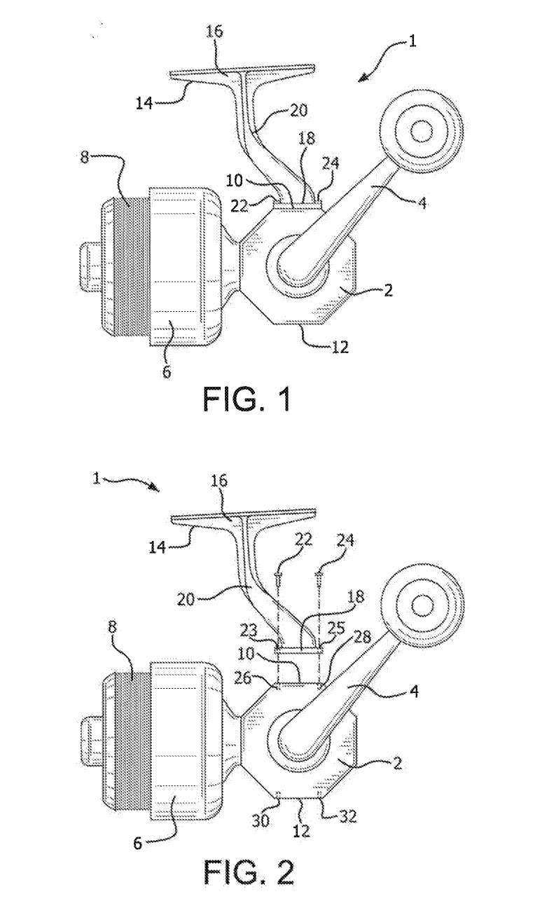

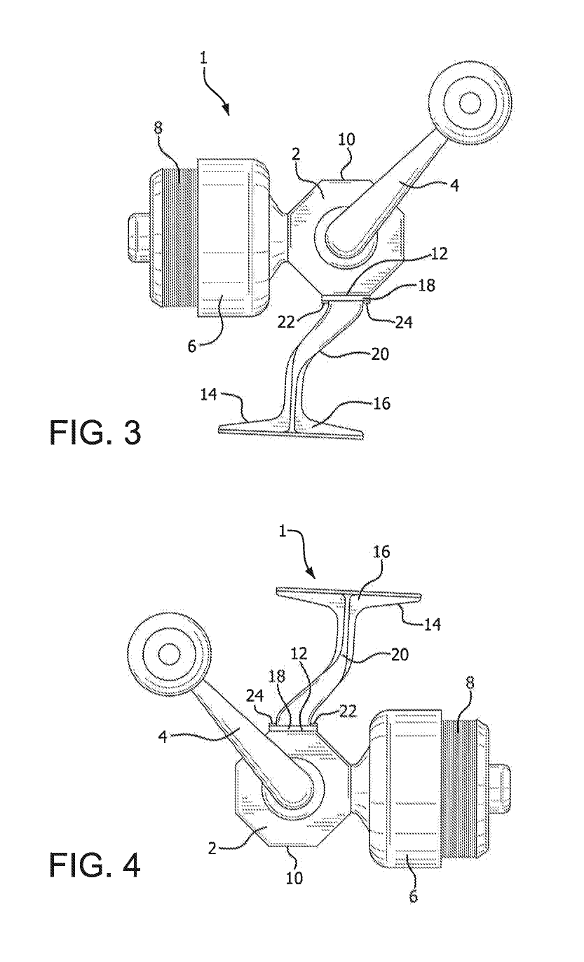

FIG. 1 shows reel assembly 1 with foot member 14 secured to top surface 10 of reel housing 2. In this configuration, cranking handle 4 is on the left side of the reel housing, to facilitate left-handed cranking of reel assembly 1. When it is desired or necessary to utilize reel assembly 1 for right-handed cranking, screws 22 and 24 are unscrewed and removed from threaded openings 26 and 28. Foot member 14 is then removed from top surface 10 of housing 2 and placed on bottom surface 12 of the housing, where it is secured by means of screws 22 and 24 through openings 23 and 25 and then through threaded openings 30 and 32. See FIGS. 2 and 3. Reel assembly 1, rotated 180°, is then configured for right-handed cranking. See FIG. 4.

Thus, by the present invention fishing reel assemblies may be easily and quickly converted from right to left-handed cranking and vice versa, by simply changing the position of the foot member fishing rod support. This permits the cranking handle to, at all times, remain in the same location, on the same side of the housing, thereby eliminating extra openings within and through the housing. This results in the waterproof nature of the housing being greatly enhanced and the gearing within the housing being protected from unwanted water or moisture. It is noted that screw openings 26, 28, 30, and 32 are formed within the outer framing of housing 2. These openings do not penetrate into the space within the housing in which the gearing is located.

Housing 2, as shown in the drawings, is octagonal in configuration. However, it is contemplated that the shape of the housing can be circular, oval, rectangular, or any polygon shape of choice. Regardless of the shape of the housing, there will still be opposing top and bottom surfaces and the housing's base section will be configured appropriately to mate flush with these surfaces.

As a practical matter of operation, when the position of foot member 14 is changed, the drive pinion gearing within housing 2 must be manually repositioned in relation to the main. drive gear, so as to ensure for the proper rotational direction of cranking handle 4 and, hence flyer unit 6 and spool 8.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. An interchangeable reel assembly comprising:
a reel housing having opposing top and bottom surfaces and a laterally extending cranking handle, said handle being permanently attached at a single location on one side of the reel housing;
a flyer unit rotatable in relation to the reel housing;
a foot member extending up from the housing, said foot member comprising a fishing rod supporting upper section, a lower base section, and an intermediate section interconnecting the upper and lower sections; and
attachment means for removeably connecting the lower base section of the foot member to either the top surface or the bottom surface of the housing, whereby the attachment means connection to the top surface results in right-handed handle cranking return and the attachment means connection to the bottom surface of the housing results in left-handed handle cranking.

2. The interchangeable reel assembly as in claim 1 wherein the attachment means comprises first and second attachment means, the first attachment means for connecting the lower base section of the foot member to the top surface of the housing and the second attachment means for connecting the lower base section of the foot member to the bottom surface of the housing.

3. The interchangeable reel assembly as in claim 2 wherein the first attachment means comprises through openings within the lower base section of the foot member, corresponding openings within the top surface of the housing, and connectors secured within the openings and corresponding openings, and the second attachment means comprises said through openings within the lower base, corresponding openings within the bottom surface of the housing, and said connectors secured within the lower base openings in the base section and the corresponding openings within the bottom surface of the housing.

4. The interchangeable reel assembly as in claim 1 wherein the attachment means comprises through openings within the lower base section of the foot member, corresponding openings within the top surface of the housing, corresponding openings within the bottom surface of the housing, and connectors secured within the openings and corresponding openings.
